(19) United States
(12) Patent Application Publication
(10) Pub. No.: US 2008/0290571 A1
(43) Pub. Date: Nov. 27, 2008

(54) Air Spring

(76) Inventor: Hans-Peter Krauss, Garbsen/Frielingen (DE)

Correspondence Address: CONTINENTAL TEVES, INC., ONE CONTINENTAL DRIVE, AUBURN HILLLS, MI, 48326-1581, US

(21) Appl. No.: 11/579,480

(22) PCT Filed: Mar. 4, 2005
(86) PCT No.: PCT/EP2005/50972

§ 371 Date: Nov. 3, 2006

(30) Foreign Application Priority Data
May 3, 2004 (DE) 102004021586.3

(51) Int. Cl. F16F 9/18

(52) U.S. Cl. 267/124

(57) ABSTRACT

An air spring has three air spring spaces (1, 2, 3). the first and the third space increase and decrease in the same direction, while the second space increases when the other two decrease and vice versa. Connectin channels(14) between the first and the second space as well as between the first and the third space are provided with adjustable restrictors (13, 13’) to control the air flow between the chambers.

### BACKGROUND OF THE INVENTION

The invention relates to an air spring having a first air spring space and a second air spring space having variable volumes which are increased and decreased in an opposite manner with respect to one another and between which there is a connecting channel, via which compressed air is conducted from a decreased air spring space into an increased air spring space.

DE 100 25 901 A1 has disclosed a bicycle having a mechanical adjusting device with at least one double-action piston/cylinder arrangement, in which two air chambers which counteract one another are coupled to one another via a connecting line. A shutoff valve which permits pressure equalization between the air chambers in the open state is arranged in said connecting line. If the shutoff valve is closed, a piston rod is fixed, with the result that an adjustable bicycle part, a rear wheel link or a front wheel fork, is fixed in a desired position.

U.S. Pat. No. 6,581,948 B2 has disclosed a shock absorber which has an inertia valve which releases a changed passage cross section for a hydraulic fluid as a function of a pulse which is exerted on it.

Proceeding from the known prior art, the invention is based on the object of providing an air spring which can be adapted simply to the requirements of the users.

### SUMMARY OF THE INVENTION

According to the invention, this object is achieved in that, in the air spring of the generic type, a restrictor device which can be adjusted with regard to the passage is arranged in the connecting channel, in order for it to be possible thus to vary the suspension and damping properties of the air spring.

In order for it to be possible to provide maximum damping, there is provision in one development of the invention for the restrictor device to be configured such that it can be shut off, with the result that no air can flow from one air spring space to the other air spring space. If the air spring is used on a bicycle the spring strut is prevented from compressing excessively as a result of forces which are introduced into the chassis by pedaling, for example when cycling uphill.

In order for it to be possible to adjust to changing environmental conditions rapidly, the restrictor device is coupled to an actuating device which is arranged on the air spring so as to be readily accessible from the outside, and via which actuating device it is possible to set the passage amount or the flow volume. The actuating device can be configured, for example, as a rotary wheel or a lever which can be latched in corresponding positions, with the result that the desired flow cross section is set for the connecting channel. For example, the restrictor device can be screwed into the connecting channel, in order to reduce the flow cross section.

One development of the invention provides for latching elements to be arranged on the actuating device or to be assigned to the latter, which latching devices fix the restrictor device in predefined positions, with the result that the suspension and damping properties are changed in stages.

There is provision in one embodiment of the invention for the latching elements to be formed on slotted guide discs which can be rotated with respect to one another, and for one of the slotted guide discs to be assigned to the connecting channel. Said slotted guide disc is loaded by the compressed air with a force toward the second slotted guide disc in the event of a movement of the air spring, with the result that the air which is situated in the air spring acts as a spring which presses the slotted guide discs toward one another. The latching elements, for example toothing systems, are formed on the slotted guide discs themselves. In order to actuate the restrictor device, the slotted guide discs have to be separated from one another by a pressure being exerted on the slotted guide disc counter to the air pressure. After release of the actuating device, the slotted guide discs latch into one another and fix the flow cross section of the connecting channel.

At least one passage hole which can be guided into and out of the connecting channel is advantageously formed in the restrictor device. It is therefore possible by rotation of the restrictor device to move proportions of varying size of the passage hole into congruence with the connecting channel, with the result that an adaptation of the passage cross section is possible by a simple rotation of the passage hole.

As an alternative to an almost infinitely adjustable rotation, there is provision for a plurality of passage holes to be provided which preferably have different hole diameters, with the result that the suspension and damping properties of the air spring can be changed by a corresponding selection of that passage hole which is connected to the connecting channel.

In one variant of the invention, instead of a configuration of the restrictor device as aligned holes, the restrictor device is configured as a needle valve, in particular as an infinitely adjustable needle valve.

One advantageous refinement of the air spring provides for a displaceable piston rod to be arranged in the first air spring space, which displaceable piston rod protrudes into the second air spring space and has a separating piston which is assigned to the second air spring space. The separating piston forms a closure of the second air spring space, and the restrictor device is arranged in the piston rod, as is the connecting channel between the air spring spaces. A compact design of the air spring is achieved in this way.

In one variant of the invention, a third air spring space is provided which is increased or decreased in accordance with the first air spring space, that is to say operates with an identical action to the first air spring space. A connecting channel which can also serve at the same time as a connecting channel between the first air spring space and the second air spring space is likewise provided between the third air spring space and the first air spring space, the restrictor device being arranged in a connection between the first air spring space and the third air spring space and therefore being capable of producing and changing in an adapted manner a flow connection between the first air spring space and the third air spring space.

In the following text, exemplary embodiments of the invention will be explained in greater detail using the appended figures.

### BRIEF DESCRIPTION OF THE DRAWINGS

In the drawings,

FIG. 1 shows a cross-sectional view of a part of a first embodiment of an air spring;

FIG. 2 shows a cross-sectional view of a second embodiment of the air spring according to the invention; and

FIGS. 2a, 2b, 2c, 2d show different switching positions of a restrictor device.

### DETAILED DESCRIPTION OF THE DRAWINGS

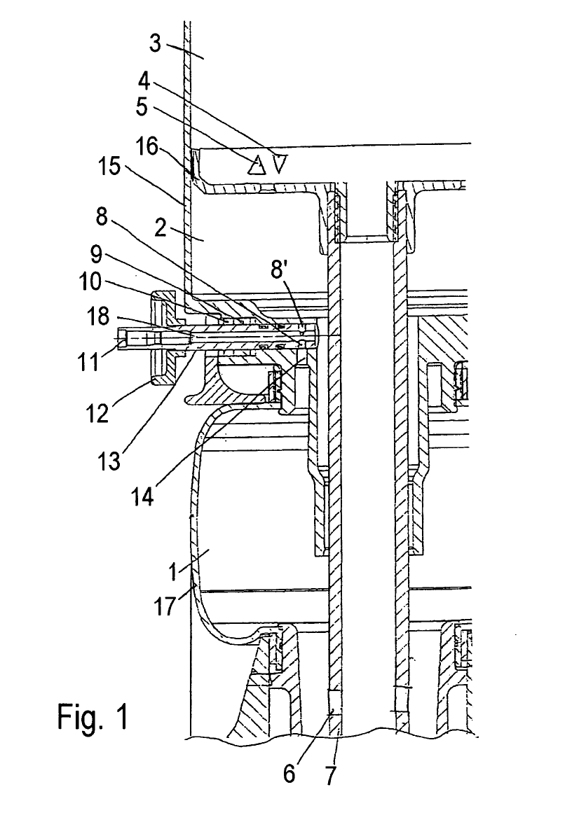

FIG. 1 partially shows a cross-sectional view of an air spring which has three air spring spaces 1, 2, 3. The first air spring space 1 is formed by a rolling bellows 17 which is fixed in a sealing manner at its end sides. The second air spring space 2 and the third air spring space 3 are formed in a housing 15 which is subdivided by a separating piston 16. The separating piston 16 is arranged on a displaceably mounted piston rod 7. If the piston rod 7 is displaced in the direction of the third air spring space 3 during compression of the air spring, the first air spring space 1 and the third air spring space 3 decrease, while the second air spring space 2 is increased. Accordingly, the air which is contained in the air spring spaces 1, 2, 3 or the gas which is present therein is compressed or relieved.

Two restrictors 4, 5 which make limited crossflow of the air possible from the third air spring space 3 in the case of the compression of the air in said air spring space into the air spring space 2 and vice versa are arranged in the separating piston 16. During rebound, the separating piston 16 and the piston rod in the illustration of the figure are moved downward, with the result that the second air spring space 2 is decreased and the air which is situated therein is compressed. Limited crossflow of the air from the air spring space 2 into the air spring space 3 is made possible via the restrictor 5. On account of the open connection between the air spring space 3 through the hollow piston rod, the open separating piston 16 and a hole 6 which is arranged in the piston rod 7, crossflow of the air is possible from the third air spring space 3 into the first air spring space 1. The restrictors 4, 5 which are arranged in the separating piston 16 are set in a fixed manner with regard to their passage cross sections and are not accessible from the outside as a rule, without the complete air spring being dismantled and disassembled.

In order to provide an adjusting possibility for a gas spring/damper unit which can be actuated manually or by motor, in particular by electric motor, in order that the suspension and damping properties can be adapted to the respective environmental conditions or user requirements, a restrictor device 13 is provided which is arranged in a connecting channel 14 between the second air spring space 2 and the first air spring space 1. In the exemplary embodiment which is shown, the restrictor device 13 comprises a restrictor bolt, in which a plurality of passage holes 8, 8′ are arranged which branch off radially from a central hole 18. The restrictor bolt 13 is mounted rotatably in a part of the housing 15, to which the rolling bellows 17 is also fastened. The restrictor bolt 13 is guided laterally out of the housing 15 and is provided at the exposed end with an actuating device 12 in the form of a handwheel or a button. The restrictor bolt 13 can be rotated via this actuating device 12, with the result that different holes 8, 8′ can be aligned flushly with respect to the connecting channel 14 which is configured as a hole. In addition to a stepped change of the passage cross section by orientation of the holes 8, 8′ having different hole diameters, it is possible for the holes 8, 8′ to be overlapped only partially with the connecting channel 14, with the result that a continuous change of the passage cross section can be realized by changing the overlap angle of the holes 8, 8′ with the connecting channel 14.

A pressure connection 11 is provided in the restrictor bolt 13, via which pressure connection 11 the air spring can be supplied with compressed air, in order to increase the pressure level overall.

The restrictor device 13 therefore forms a bypass restrictor which is arranged between the first air spring space 1 and the second air spring space 2. Different diameters of restrictor holes 8, 8′ can be brought into congruence with the connecting channel 14 by the rotation of the restrictor device 13, in order to adapt the passage cross sections to the requirements of the gas spring users. It is likewise possible to close the connecting channel 14 completely by rotation of the restrictor bolt 13, in order to bring about increased damping on account of the shut off bypass between the first air spring space 1 and the second air spring space 2. Crossflow of the compressed air from the air spring space 2 into the air spring space 1 is then possible only via the restrictor 5, the hollow piston rod 7 and the hole 6.

In order to make precise setting possible of the rotational angle of the restrictor device 13, two slotted guide discs 9 and 10 are provided, an inner slotted guide disc 9 being connected fixedly in terms of rotation to the restrictor bolt 13. An outer slotted guide disc 10 is connected fixedly in terms of rotation to the housing 15, and the slotted guide ensures that the restrictor bolt 13 has to be pressed axially inward for rotation counter to the air pressure which is present in the air spring and acts as a spring. Positively locking elements are formed in the slotted guide discs 9, 10, which positively locking elements latch only in predefined angular positions of the restrictor bolt 13, preferably when the holes 8, 8′ overlap the connecting channel 14, or when the connecting channel 14 is completely closed.

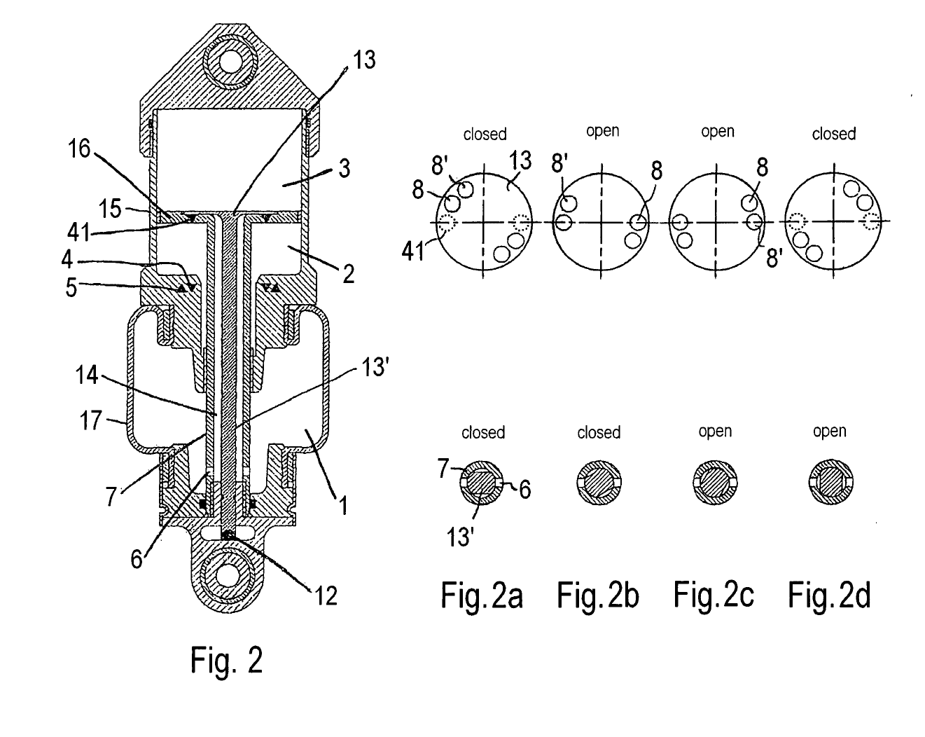

One alternative refinement of the invention is shown in FIG. 2, in which a cross-sectional view of an air spring or a gas spring/damper unit having likewise three air spring spaces 1, 2, 3 is shown. The separating piston 16 is also guided in a housing 15 here and is arranged on a hollow piston rod 7, in which a hole 6 is formed, in order to connect the air spring spaces 1, 3 to one another. The restrictors 4, 5 for the controlled crossflow of compressed air between the first air spring space 1 and the second air spring space 2 are arranged in the housing 15 in the embodiment according to FIG. 2. A restrictor device 13 is arranged in the connecting channel 14 of the hollow piston rod 7, which restrictor device 13 can be actuated rotatably via an actuating device 12, for example a lever. The restrictor device 13 has different holes 8, 8′ which are shown in plan view in FIGS. 2a and 2b in the upper illustration. Said holes 8, 8′ can be brought completely or partially into congruence with a hole 41 or a restrictor point 41 which is formed in the separating piston 16, and can thus produce a connection between the second air spring space 2 and the third air spring space 3.

The shaft 13′ of the restrictor device 13 is shown in the lower illustration of FIGS. 2a-2d and has a substantially round cross section which is provided with flattened portions, the cross section being configured in such a way that the hole 6 in the piston rod 7 is optionally closed or open. By rotation of the restrictor device 13 via the actuating device 12, it is possible to produce different connections between the air spring spaces 1, 2, 3 and therefore to set different spring stiffnesses for the entire system. FIG. 2a shows a first position, in which both the restrictor or hole 41 and the hole 6 are closed. An air exchange does not take place between the first air spring space 1 and the third air spring space 3, and pressure equalization can take place only via the restrictor 4 which is arranged in the housing 15.

The hole 6 in the piston rod 7 is closed in FIG. 2b, and a connection is produced between the second air spring space 2 and the third air spring space 3 on account of the complete congruence of the hole 8 and the restrictor 41, which results in reduced damping and softer spring characteristics. FIG. 2c shows the setting with the lowest damper action, in which a connection is possible between the second air spring space and the third air spring space via the hole 41 and the hole 8′, and at the same time an exchange can take place between the first air spring space 1 and the third air spring space 3 via the open hole 6.

FIG. 2d shows an open connection between the first air spring space 1 and the third air spring space 3 via the connecting channel 14 and the open hole 6 in the piston rod 7. A connection between the second air spring space 2 and the two other air spring spaces 1, 3 via the restrictor device 13 is shut off.

In the embodiment which is shown, four positions and connections of the air spring spaces 1, 2, 3 can be produced or shut off with the pneumatic restrictor device 13. Closure of all the restrictors 4, 5, 41 leads to higher spring stiffnesses for the entire system, which limits undesired spring movements.

One example for the application of a gas spring of this type is a bicycle with suspension. An adaptation to the requirements of the rider is achieved by different air spring spaces 1, 2, 3 being separated from one another by restrictors 4, 5, 41, 13. The gas spring/damper unit according to FIG. 2 can also be adjusted in an infinitely variable manner via the actuating device 12, for example a lever or a handwheel. The pneumatic shut off function affords the advantage that the suspension still functions in the event of relatively great obstacles, and the ground contact, for example of a rear wheel, continues to exist, in order to transmit brake or drive forces.

1.-10. (canceled)

11. An air spring having a first air spring space (1) and a second air spring space (2), the air spring spaces having variable volumes which are increased and decreased in an opposite manner with respect to one another and having a connecting channel (14), via which compressed air is conducted from one air spring space into the other air spring space, wherein a restrictor device (13) which can be adjusted with regard to the passage is arranged in the connecting channel (14).

12. The air spring as claimed in claim 11, wherein the restrictor device (13) is configured such that it can be shut off.

13. The air spring as claimed in claim 11, wherein the restrictor device (13) is coupled to an actuating device (12) which is arranged on the air spring so as to be accessible from the outside.

14. The air spring as claimed in claim 13, wherein the actuating device (12) is assigned latching elements which fix the restrictor device (13) in predefined positions.

15. The air spring as claimed in claim 14, wherein the latching elements are formed on a first and a second slotted guide disc (9, 10) which can be rotated with respect to one another, wherein by way of the first slotted guide disc, which is assigned to the connecting channel (14), compressed air is loaded with a force in the direction of the second slotted guide disc (10).

16. The air spring as claimed in claim 11, wherein at least one passage hole (8, 8′) which can be guided into and out of the connecting channel (14) is formed in the restrictor device (13).

17. The air spring as claimed in claim 16, wherein the restrictor device (13) is mounted rotatably and the passage hole (8, 8′) can be pivoted into the connecting channel (14).

18. The air spring as claimed in one of claim 11, wherein the restrictor device is configured as an adjustable needle valve.

19. The air spring as claimed in claim 11, wherein a displaceable piston rod (7) is arranged in the first air spring space (1), which displaceable piston rod (7) protrudes with an end into the second air spring space (2) and, on the end, has a separating piston (16) which forms a closure of the second air spring space (2), wherein the restrictor device (13) is arranged in the piston rod (7).

20. The air spring as claimed in claim 11, with a third air spring space (3) which is increased and decreased in the same direction as the first air spring space (1), wherein an adjustable restrictor device (13) is arranged in a connection between the first air spring space (1) and the third air spring space (3).
